(19) United States
(12) Patent Application Publication
(10) Pub. No.: US 2016/0177617 A1
(43) Pub. Date: Jun. 23, 2016

(54) MOVABLE COMBINED WALL DEVICE

(71) Applicant: OME TECHNOLOGY CO., LTD., New Taipei City (TW)

(72) Inventors: KUO-FU LIAO, TAIPEI CITY (TW); SHI-HWA LO, TAIPEI CITY (TW); CHIEN-HSIANG MIAO, TAIPEI CITY (TW); HSIN CHIEN LIEN, NEW TAIPEI CITY (TW)

(21) Appl. No.: 14/644,554

(22) Filed: Mar. 11, 2015

(30) Foreign Application Priority Data
Dec. 19, 2014 (TW) 103144528

(51) Int. Cl. E06B 3/48; E06B 1/36

(52) U.S. Cl. CPC E06B 3/483; E06B 1/36

(57) ABSTRACT

A movable combined wall device comprises N number of movable combined wall modules and N-1 number of first coupling units. N is an integer. Each movable combined wall module includes two fixing frames, a first operable window, and a second operable window. Each fixing frame has two oppositely arranged surfaces, each of the surfaces has a guiding rail and a coupling slot arranged thereon. The first operable window has a side coupled to a side of the second operable window. Another side of the first operable window and another side of the second operable window are respectively coupled to two separate guiding rails. Accordingly, the second operable window can move along two guiding rails towards one side of the first operable window. Each first coupling unit can be simultaneously coupled to two coupling slots of two fixing frames, so that two movable combined wall modules are mutually coupled.

### BACKGROUND OF THE INVENTION

1. Field of the Invention

The instant disclosure relates to a movable wall device; in particular, to a movable combined wall device.

2. Description of Related Art

Typically, windows and window frames, screens or partition plates tend to be fixed arrangements and are not capable of being altered into such arrangements for desired settings, which inconveniences users. As a result, movable windows and window frames, walls or partition plates such as vertically operable blinds, slidable screens or compartment panels, etc. are gradually being developed. However, such active windows and window frames, walls or partition plates are still unable to effectively meet the needs of users. In order to provide movability, users can not increase or decrease the number of windows or window frames as well as the quantity of shutters or partitions according to their needs.

To address the above issues, the inventor strives via associated experience and research to present the instant disclosure, which can effectively improve the limitation described above.

### SUMMARY OF THE INVENTION

The objective of the instant disclosure is to provide a movable combined wall device that addresses the issues regarding the inability of the windows and window frames, screens, or partition plates to be interchangeable in terms of arrangement or in quantity based on user's needs.

In order to achieve the aforementioned objectives, according to an embodiment of the instant disclosure, a movable combined wall device is provided. The movable combined wall device includes N number of movable combined wall modules and N-1 number of first coupling units. N is an integer. Any movable combined wall module includes two fixing frames, a first operable window, and a second operable window. Each fixing frame has two surfaces arranged to face one another, one being an inner side surface and the other an outer side surface. Each of the inner side surfaces has a guiding rail arranged thereon, and each of the outer side surfaces has a coupling slot arranged thereon. The first operable window is arranged between two fixing frames, and the first operable window has a side coupled to two fixing frames. The second operable window is arranged between two fixing frames, and the second operable window has a side coupled to another side of the first operable window. The second operable window has another side respectively coupled to two separate guiding rails. Accordingly, one side of the second operable window can move proximate to or distal from one side of the first operable window fixed on the two fixing frames along two guiding rails. Each first coupling unit can be simultaneously coupled to two coupling slots of two fixing frames, so that two movable combined wall modules are mutually coupled.

The instant disclosure provides the following improvements. With the coupling between the first operable window, the second operable window, and their respective fixing frames, the second operable window can move along two guiding rails to be close to or away from the first operable window. This way, users can cover up at least a portion of a main plane that is defined by the two fixing frames. Moreover, with the first coupling units, the movable combined wall modules can be mutually coupled and be arranged on the same transversal axis or longitudinal axis. In other words, the movable combined wall modules can be coupled and arranged in a vertical arrangement or a horizontal arrangement in order to effectively provide flexible configurations as needed.

In order to further understand the instant disclosure, the following embodiments and illustrations are provided. However, the detailed description and drawings are merely illustrative of the disclosure, rather than limiting the scope being defined by the appended claims and equivalents thereof

### BRIEF DESCRIPTION OF THE DRAWINGS

FIG. 1 is an assembled view of a movable combined wall device in accordance with a first embodiment of the instant disclosure;

FIG. 2 is an exploded view of a portion of the movable combined wall device in accordance with the first embodiment of the instant disclosure;

FIG. 3 is an exploded view illustrating a single movable combined wall module of the movable combined wall device in accordance with the instant disclosure;

FIG. 4 is a detail view illustrating a portion of a fixing cover and a first operable window of the movable combined wall device in accordance with the instant disclosure;

FIG. 5 is a detail view illustrating a sliding unit and a second operable window of the movable combined wall device in accordance with the instant disclosure;

FIG. 6 is a detail view illustrating a coupling slot and a first coupling unit of the movable combined wall device in accordance with the instant disclosure;

FIG. 7 is a top view illustrating two movable combined wall modules simultaneously coupled to a first coupling unit of the movable combined wall device in accordance with the instant disclosure;

FIG. 8 is a detail view illustrating the coupling slot and a second coupling unit of the movable combined wall device in accordance with the instant disclosure;

FIG. 9 is a top view illustrating the movable combined wall module fixed to a fixed wall via two second coupling units of the movable combined wall device in accordance with the instant disclosure;

FIG. 10 is a schematic diagram of the movable combined wall device in accordance with a second embodiment of the instant disclosure;

FIG. 11 is a schematic diagram illustrating a third coupling unit of the movable combined wall device in accordance with the instant disclosure;

FIG. 12 is an explode view illustrating two movable combined wall modules of the movable combined wall device in accordance with the second embodiment of the instant disclosure;

FIG. 13 is a detail view illustrating portions of two movable combined wall modules of the movable combined wall device in accordance with the second embodiment of the instant disclosure; and

FIG. 14 is a detail cross-sectional view illustrating the third coupling unit arranged in the coupling slot of the movable combined wall device in accordance with the second embodiment of the instant disclosure.

### DETAILED DESCRIPTION OF THE PREFERRED EMBODIMENTS

The aforementioned illustrations and detailed descriptions are exemplarity for the purpose of further explaining the scope of the instant disclosure. Other objectives and advantages related to the instant disclosure will be illustrated in the subsequent descriptions and appended drawings.

[First Embodiment]

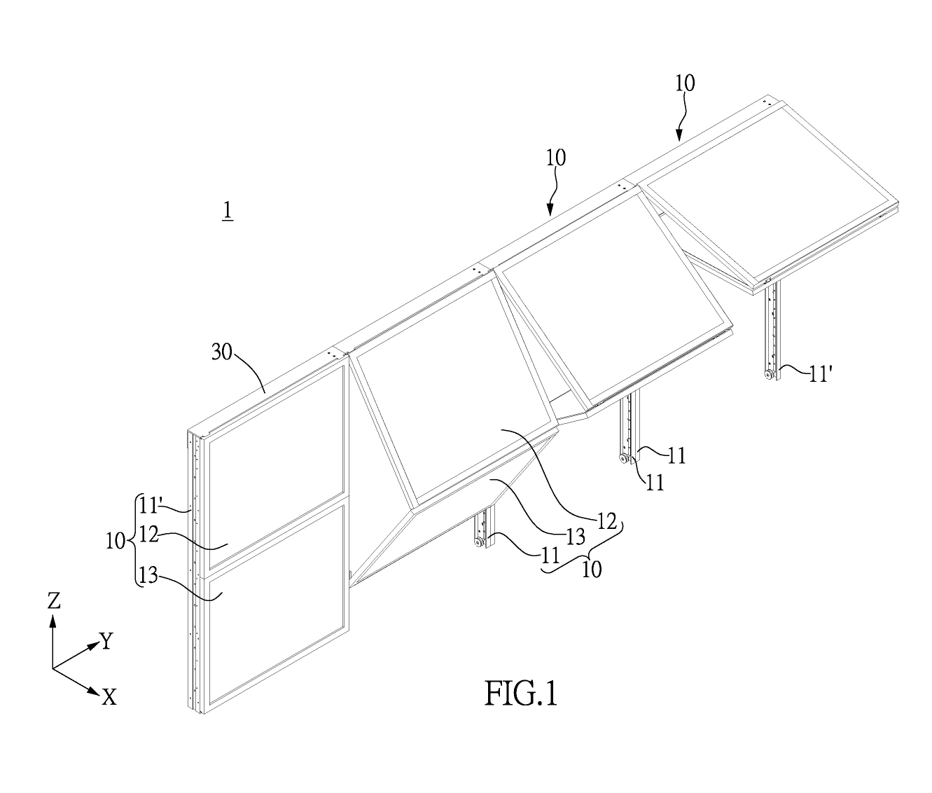

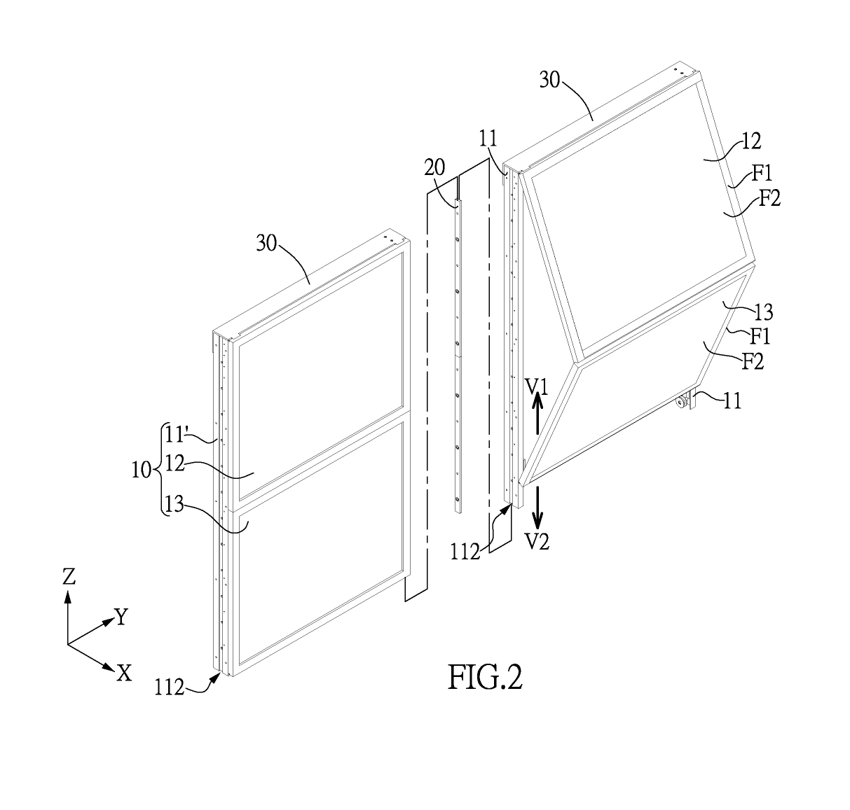

Please refer to FIGS. 1 TO 3 as the assembled and exploded views of the movable combined wall device in accordance with the first embodiment of the instant disclosure. As shown in FIGS. 1 and 2, the movable combined wall device 1 can include four movable combined wall modules 10 and a plurality of first coupling units 20. Two adjacent movable combined wall modules 10 are mutually coupled via a first coupling unit 20, and four movable combined wall modules 10 can accordingly be arranged alongside one another on the same transversal axis (Y axis as shown in the figure). In the instant disclosure, the movable combined wall modules 10 are not only limited to four, but can be more or less as required. Moreover, the arrangement of the movable combined wall modules 10 can also be altered and not limited only to the “alongside one another” (side by side) configuration as provided in the examples above, for example, the modules can be arranged longitudinally with respect to the device (further disclosed in another embodiment).

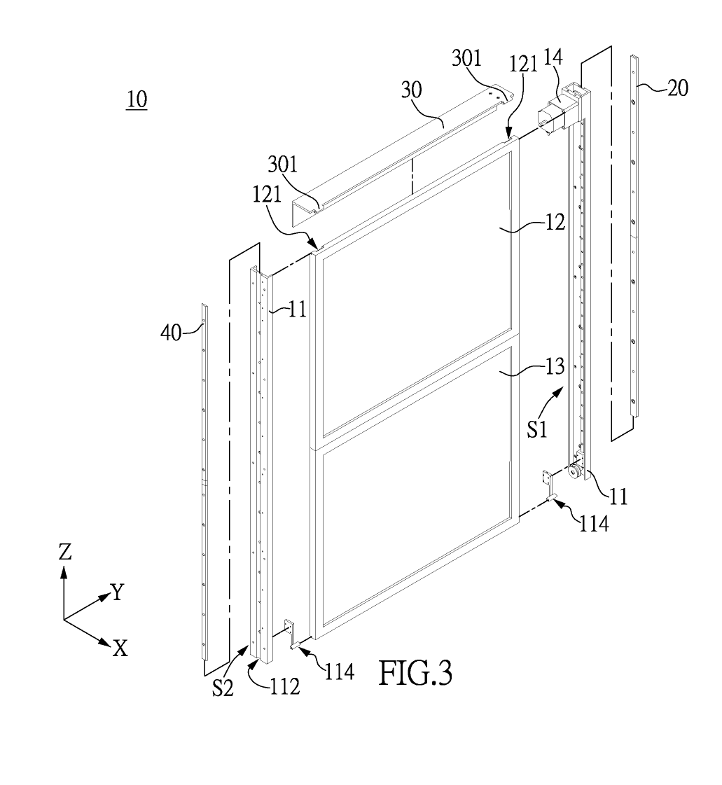

As shown in FIGS. 3, 5, and 6, each movable combined wall module 10 includes two fixing frames 11, two guiding rails 111, two pivotable units 114, a first operable window 12 and a second operable window 13. Two fixing frames 11 are arranged face to face from one another to define a main plane (Y-Z plane as shown in figure). The two fixing frames 11 each have two surfaces, one surface that faces towards another surface of another fixing frame 11 is defined as an inner side surface 51, and the other surface facing away from another surface of another fixing frame 11 is defined as an outer side surface S2. The inner side surface 51 of each fixing frame 11 has a guiding rail 111 arranged thereon, and the outer side surface S2 of each fixing frame 11 has a coupling slot 112 formed thereon. Each guiding rail 111 has a sliding unit 113 and a pivotable unit 114 arranged therein. The sliding unit 113 can freely move along the guiding rail 111, the pivotable unit 114 is securely arranged on the sliding unit 113 and can freely move in the guiding rail 111 along with the sliding unit 113. Preferably, the guiding rail 111 can be a linear rail.

Please refer once again to FIGS. 1 and 2. The first operable window 12 has a side mutually coupled to a side of the second operable window 13, and another side of the first operable window 12 is securely arranged on a side of two fixing frames 11 while another side of the second operable window 13 can still movably fixed on two pivotable units 114, so that the second operable window 13 can move along two guiding rails 111 towards a direction where the first operable window 12 is fixed onto the fixing frame 11. The first operable window 12 and the second operable window 13 can both be separately assembled from a window frame F1 and a window body F2. The window body F2 can be made of transparent glass or non-transparent glass, or any other materials as needed, but not limited to the examples provided herein.

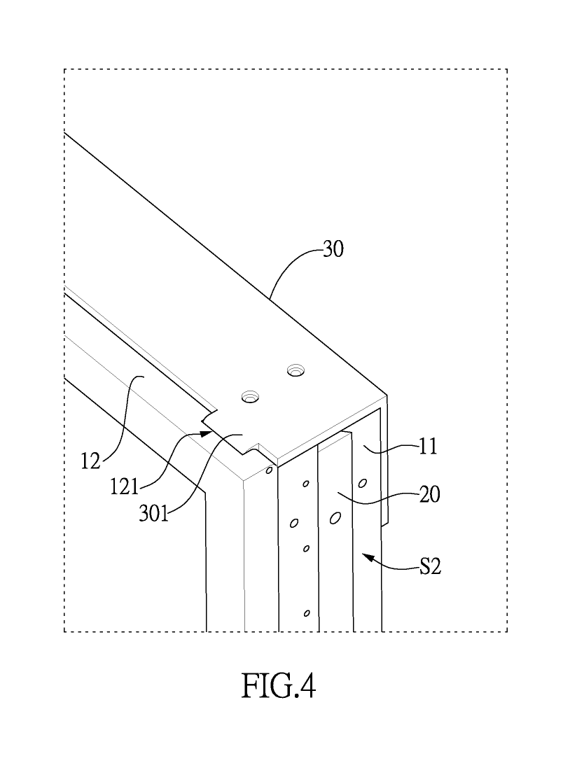

Please refer to FIGS. 3 and 4 for further details of the first operable window 12. Each movable combined wall module 10 can further include a fixing cover 30 that can be correspondingly and fixedly arranged on a side of both of the two fixing frames 11 (a side where the first operable window 12 is fixedly arranged). The fixing cover 30 has two connecting members 301. The first operable window 12 can have two connection portions 121 that correspond to the connecting members 301, so that the first operable window 12 can be mutually and pivotally connected to two connecting members 301 of the fixing cover 30 through two connecting portions 121 while being movable and arranged at a side of both of the two fixing frames 11. The first operable window 12 can be directly and pivotally coupled to an end of both of the two fixing frames 11 or pivotally connected to an end of both of the two fixing frames via another sliding unit.

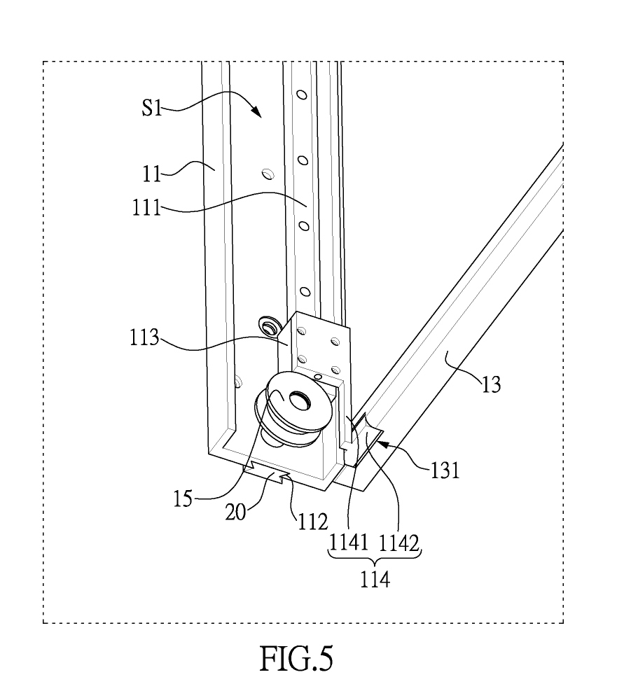

Please refer to FIGS. 3 and 5 for further details of the second operable window 13. Each pivotable unit 114 can be parallel to the direction of the guiding rail 11 (Z axis as shown in FIG. 3) and extend towards a distal end of the fixing frame 11 to form a support arm 1141. The support arm 1141 can extend towards the direction of another fixing frame 11 (Y axis as shown in FIG. 3) to form a pivot axle 1142. Each second operable window 13 has a side that corresponds to two pivot axles 1142 of two fixing frames 11, and that side can correspondingly include two pivoting portions 131, so that the second operable window 13 can be mutually coupled to two pivot axles 1142 arranged in two fixing frames 11 via two pivoting portions 131. Also as shown in FIG. 2, the second operable window 13 can move along the guiding rail 111 in a first longitudinal direction V1 and a second longitudinal direction V2, which can change the angle between the first and the second operable windows 12 and 13 and change the mode of the first and the second operable windows 12 and 13 to cover the main plane (Y-Z plane in figure). In other embodiments, each pivotable unit 114 can be integrally formed and arranged along with each sliding unit 113.

Please refer to FIG. 3. In the preferred embodiment, each movable combined wall module 10 can further include a driving unit 14 that can be securely arranged at an end of one of the fixing frames 11 while being mechanically connected and fixed to the sliding unit 113 of the fixing frame 11, so that the sliding unit 113 can be driven to move on the guiding rail 111 and the second operable window 13 can be driven proximate to or distal from the first operable window 12. As shown in FIGS. 3 and 5, another side of the fixing frame 11 having the driving unit 14 can have at least one rotating member 15 arranged thereon, so that the driving unit 14 can facilitate the sliding unit 113 to move in the guiding rail 111. The rotating member 15, for example, can be a belt, rollers (as shown in figures), etc.

In more preferred embodiments, the movable combined wall device 1 can further include a control module (not shown in figures), which can be electrically connected to each movable combined wall module 10. Specifically, the control module can include a controller (not shown) that allows users to control operations, so that a user can change the angle (as shown in FIG. 1) between the first and the second operable windows 12 and 13 as needed.

The movable combined wall device 1 not only can modify the angle between the first and second operable windows 12 and 13 of each movable combined wall module 10 according to needs, any two movable combined wall module 10 can further be mutually coupled via a first coupling unit 20 as shown in FIGS. 1 and 3. In other words, a first coupling unit 20 can simultaneously couple to two coupling slots 112 of two adjacent movable combined wall modules 10, so that the two movable combined wall modules 10 are mutually fixed.

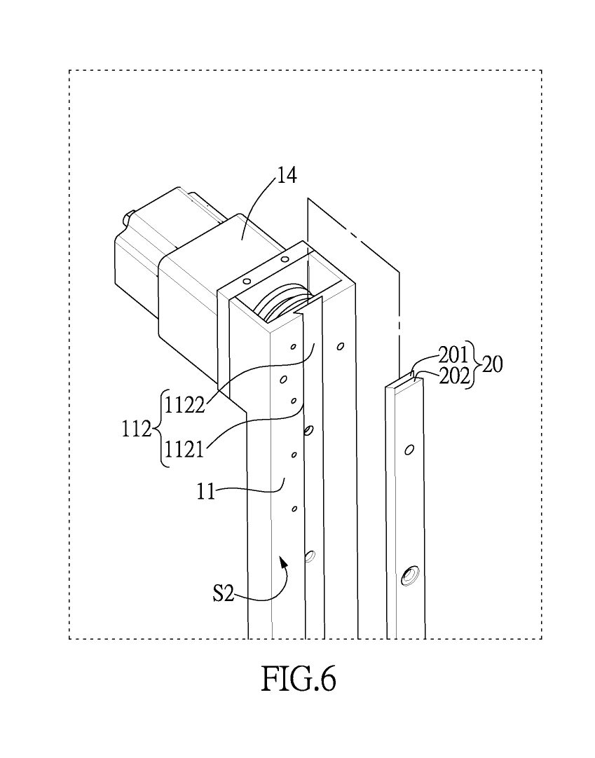

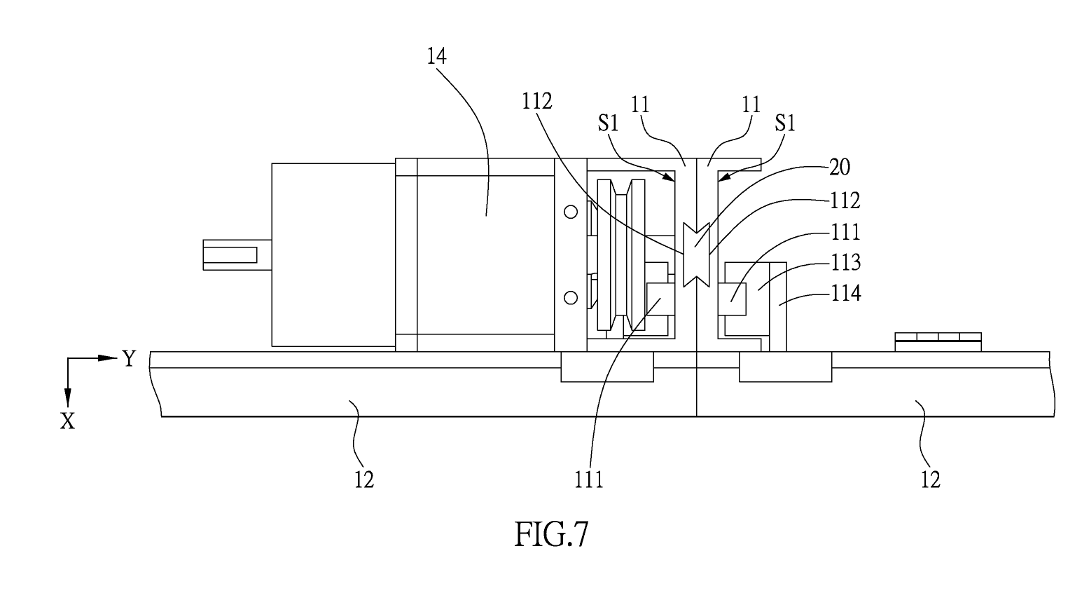

In the preferred embodiment, as shown in FIGS. 6 and 7, each coupling slot 112 of the movable combined wall module 10 can form an opening 1121 at the outer side surface S2 of the fixing frame 11. The opening 1121 has a surface area, and the coupling slot 112 has a bottom surface 1122 formed in the fixing frame 11, the bottom surface 1122 has a surface area, and the surface area of the opening 1121 is smaller than that of the bottom surface 1122. In other words, the coupling slot 112 has a cross-section resembling a trapezoid in the instant embodiment, so that when the first coupling unit 20 is coupled in the coupling slot 112, the first coupling unit 20 is restricted to move in specific directions (Z axis as shown in FIG. 3), cannot move in other directions (such as X or Y axis as shown in FIG. 7), and can be effectively and stably coupled. Moreover, each first coupling unit 20 can increase the contact surface area with respect to the coupling slot 112 depending on the design of the cross-section as aforementioned in order to effectively increase contact friction between the two, and effectively prevent each movable combined wall module 10 from outward lateral forces (X or Y axis directions as shown in FIG. 1).

Notably, the first coupling unit 20, as shown in FIG. 6, can be assembled from a first fixing member 201 and a second fixing member 202. In the instant embodiment, the first fixing member 201 and the second fixing member 202 of each first coupling unit 20 can have identical shapes. Specifically, the first coupling unit 20 of the instant embodiment connects two movable combined wall modules 10 having two coupling slots 112 with identical shapes, whereas the first fixing member 201 and the second fixing member 202 have the same shapes. In other words, the first coupling unit 20 can have different shapes according to the shapes of the coupling slots 112 of two movable combined wall modules 10 to correspond to the first and second fixing members 201 and 202 having different shapes.

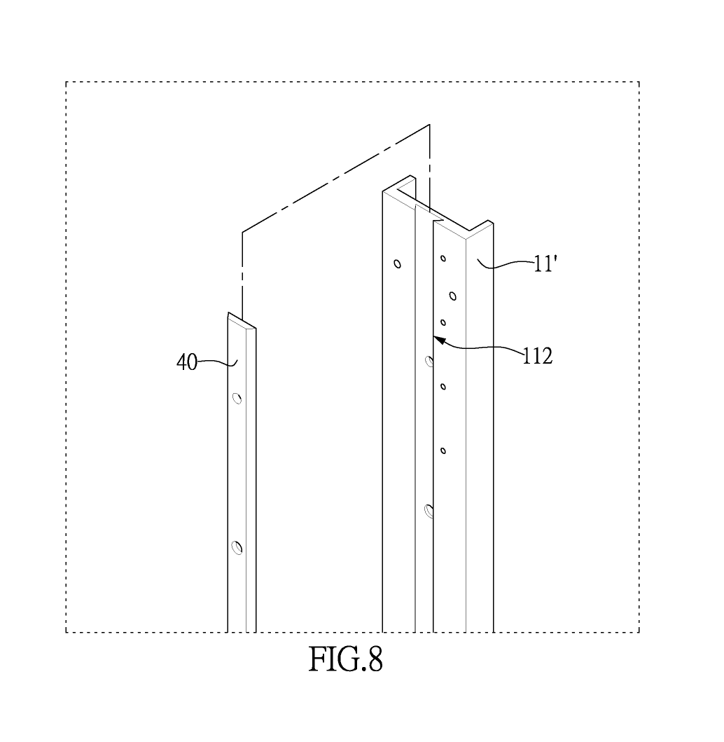

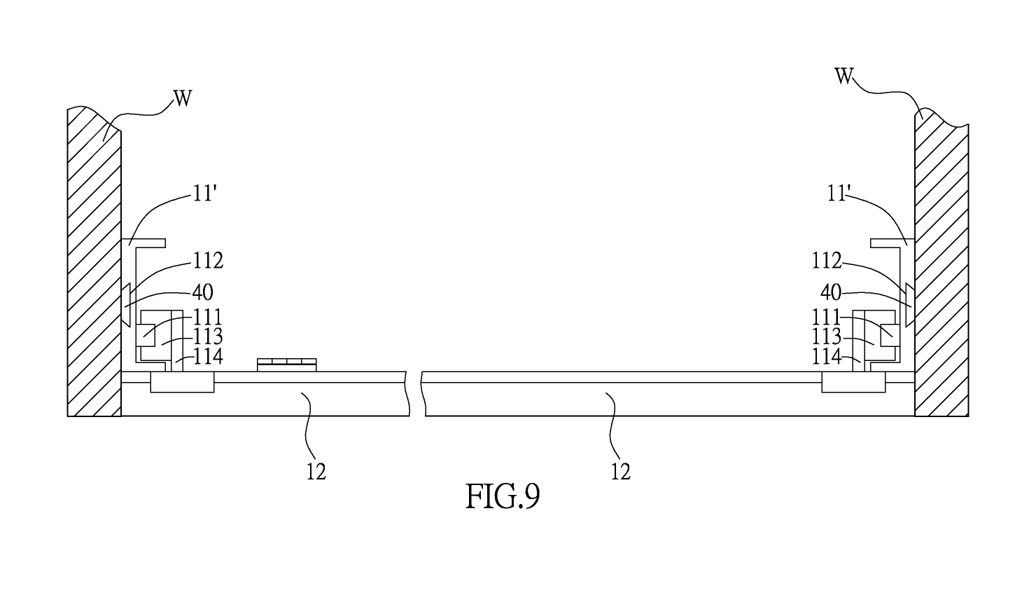

Please refer to FIGS. 1, 2, 8 and 9. The movable combined wall device 1 can also be securely arranged between two fixed walls W as necessitated by users. Specifically, among the movable combined wall modules 10 that are mutually coupled to one another as shown in FIG. 1, two fixing frames 11′ that are not mutually coupled to the first coupling unit (as shown in FIG. 2) can separately be coupled to a second coupling unit 40 (as shown in FIG. 8), so that the movable combined wall modules 10 can be securely arranged between two fixed walls W (as shown in FIG. 9) via two second coupling units 40. The second coupling unit 40 can first be mutually coupled to the coupling slot 113 of the movable combined wall module 10 as needed, then further be securely arranged on the fixed wall W. Alternatively, the second coupling unit 40 can first be securely arranged on the fixed wall W, and the movable combined wall module 10 can then be correspondingly coupled to the second coupling unit 40.

Notably as shown in FIG. 8, the second coupling unit 30 and the corresponding coupling slot 12 have cross-sectional areas resembling a trapezoid, which can effectively prevent the coupling slot 112 of movable combined wall module 10 from being easily removed or falling out from the second coupling unit 40 when an external force along the direction of the Y axis is applied to the movable combined wall module 10. Moreover, with the design of the cross-sectional area of the second coupling unit 40, the coupling slot 112 of the movable combined wall module 10 can be prevented from being easily removed or falling out from the second coupling unit 40 when an external force along the direction of the X axis is applied to the movable combined wall module 10.

In summary, the movable combined wall device 1 can have N number of movable combined wall modules 10, and correspondingly have N-1 number of first coupling units 20 and two second coupling units 40. Accordingly, the movable combined wall modules 10 can be mutually coupled to one another via the coupling between the first coupling units 20 and be arranged on the same transversal axis. The movable combined wall modules 10 that are mutually coupled can further be arranged between two fixed walls W via two second coupling units 40.

[Second Embodiment]

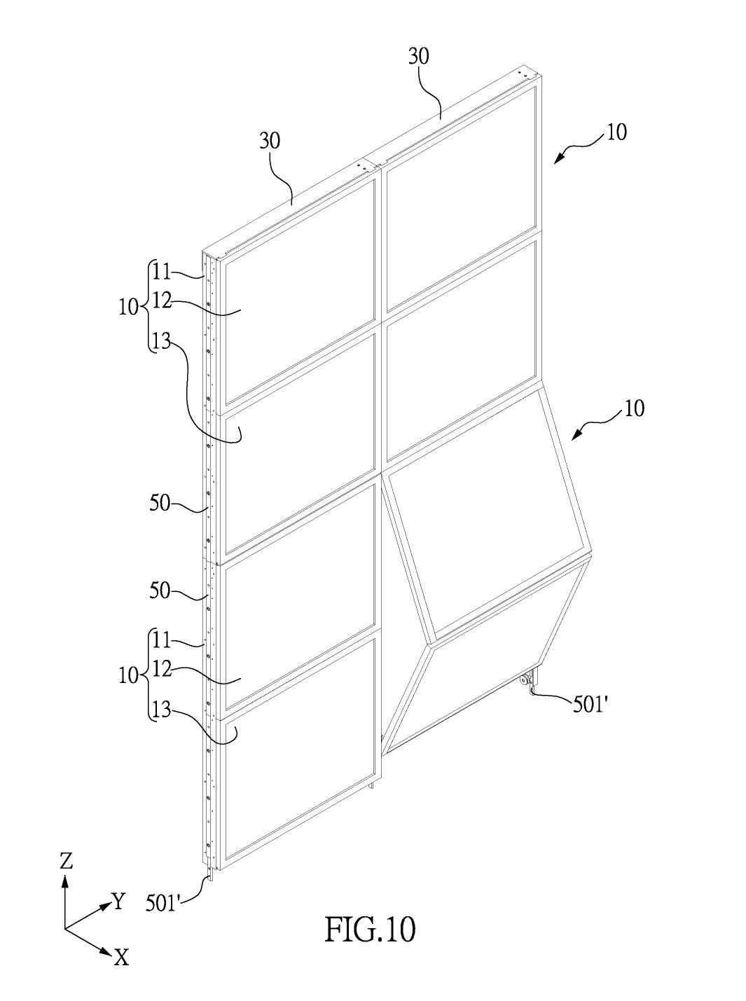

Please refer to FIGS. 10 to 14 as the schematic diagrams of the movable combined wall device 10 in accordance with the second embodiment of the instant disclosure. The previous embodiment provides two movable combined wall modules 10 that are coupled via the first coupling unit 20, and are arranged on the same transversal axis. In the instant embodiment, the first coupling unit 20 is applied in another manner, so that two movable combined wall modules 10 are mutually coupled and arranged on the same transversal axis 9 (Y axis as shown in FIG. 10) or the same longitudinal axis (Z axis as shown in FIG. 10). Namely, the first coupling unit 20 of the instant disclosure has another embodying mode which can provide two movable combined wall modules 10 with more diverse assembling modes (as shown in FIG. 10). The first coupling unit 20 is the third coupling unit 50 from herein after.

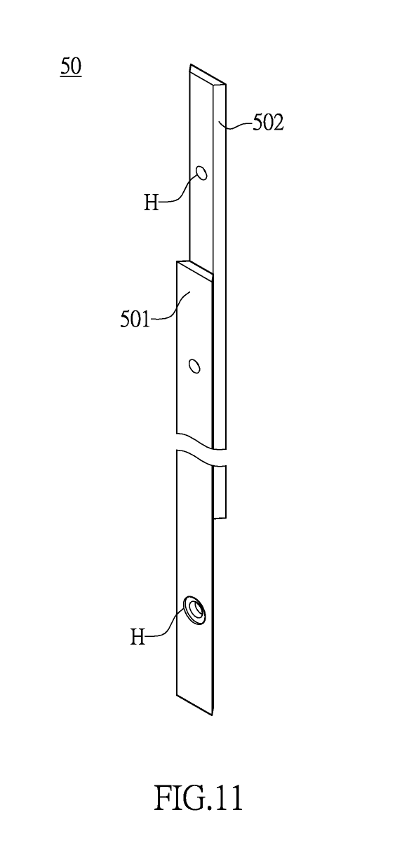

Please refer to FIG. 11 as the detailed view of portions of the third coupling unit 50. The third coupling unit 50 can be comprised of a first fixing member 501 and a second fixing member 502, and the first fixing member 501 at one end of the third coupling unit 50 is protruded relatively more than the second fixing member 502, whereas the second fixing member 502 at another end of the third coupling unit 50 is protruded relatively more than the first fixing member 501. Namely, the first fixing member 501 and the second fixing member 502 of the third coupling unit 50 are arranged in a misaligned manner.

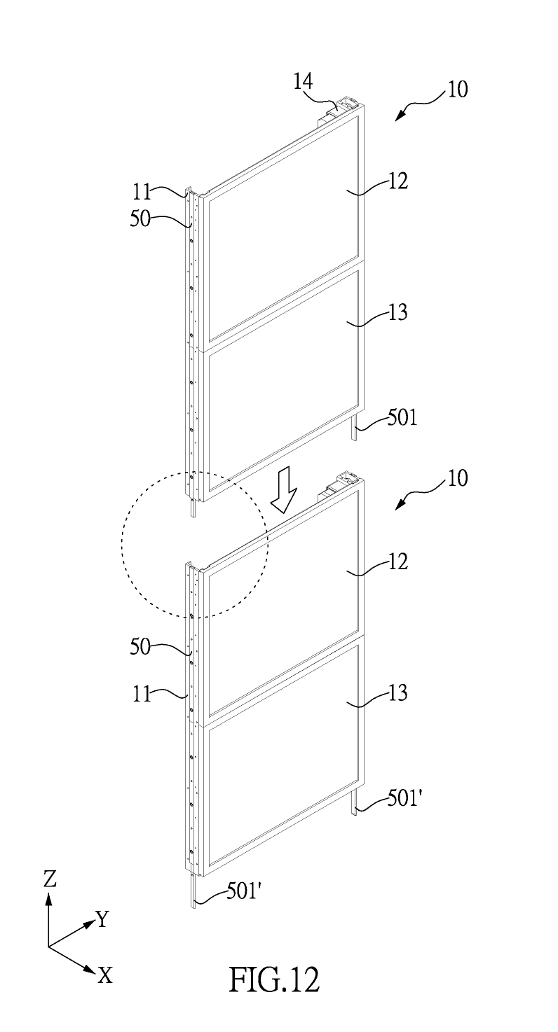

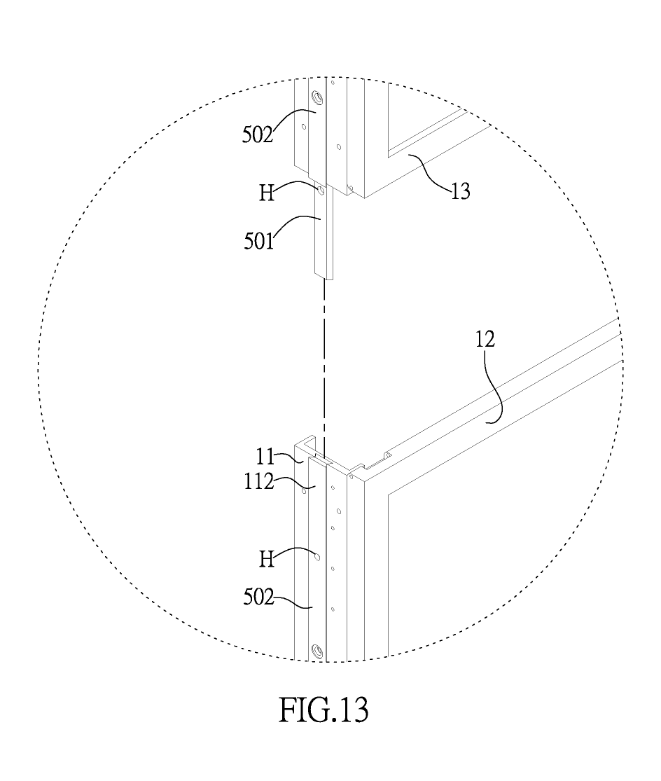

Please refer to FIGS. 12 and 13. When the two fixing frames 11 of each of the movable combined wall modules 10 have the third coupling units 50 arranged thereon, portions of the first fixing members 501 at one end of both of the two third coupling units 50 are exposed from a side of the movable combined wall modules 10, and are not exposed at another end of each of the third coupling units 50. One of the movable combined wall modules 10 can correspondingly couple the exposed third coupling unit 50 to another side of the movable combined wall module 10 not exposing the third coupling unit 50 in order to provide mutual coupling and be arranged on the same longitudinal axis.

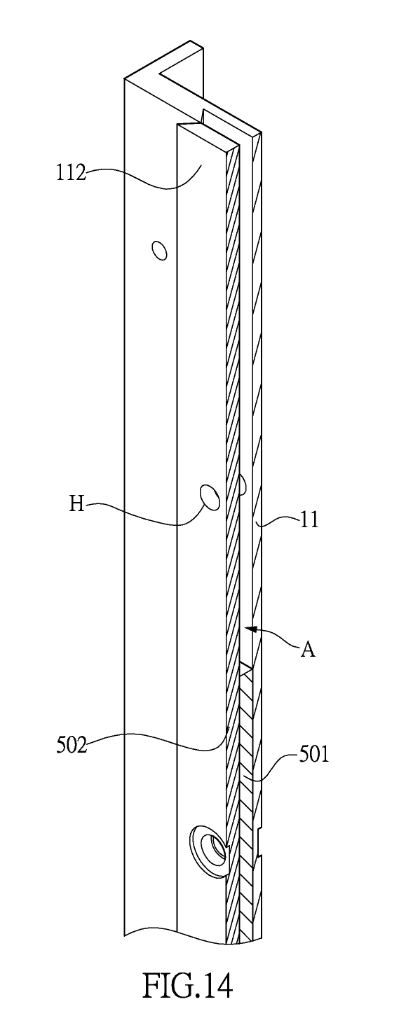

Furthermore, FIG. 14 is a cross-sectional view that illustrates one end of the third coupling unit 50 not exposed from the movable combined wall module 10. As shown in the figure, the second fixing member 502 of the third coupling unit 50, the bottom surface 1122 of the coupling slot 112 arranged thereon, and an end surface of the first fixing member 501 can cooperatively define a fixing slot A, so that the first fixing member 501 of another movable combined wall module 10 can be accommodated in the slot A. Namely, two movable combined wall modules 10 are mutually coupled and arranged on the same longitudinal axis. Two fixing frames 11 from two respective movable combined wall modules 10 have identical shapes and are mutually corresponding in a top-bottom arrangement. The two fixing frames 11 have coupling slots 112 that have shapes identical to the first fixing members 501 of the third coupling units 50, so that each first fixing member 501 is respectively coupled to the corresponding coupling slot 112. Accordingly, each third coupling unit 50 can correspondingly receive the first fixing member 501 of another movable combined wall module 10 at one end of the coupling slot 112 where the fixing slot A is arranged.

In the preferred embodiment, as shown in FIGS. 13 and 14, the first fixing member 501 and second fixing member 501 at two ends of each third coupling unit 50 can respectively have a locking hole H. Accordingly, when the first fixing member 501 of one of the movable combined wall modules 10 is correspondingly arranged in the fixing slot A of another movable combined wall module 10, the locking hole H of the first fixing member 501 is aligned with the locking hole H of the fixing slot A facing the second fixing member 502, so that different first fixing members 501 and second fixing members 502 belonging to different movable combined wall modules 10 can be mutually interlocked via locking member(s) (not shown), and the two movable combined wall modules 10 can be securely coupled to one another.

Notably, as shown in FIG. 12, the movable combined wall modules 10 that are arranged on the same longitudinal axis via the coupling between multiple third coupling units 50 can securely arrange the exposed first fixing members 501′ to the ground, which can in turn facilitate the movable combined wall modules 10 to be securely fixed to the ground. In other words, the movable combined wall modules 10 can simultaneously secure two fixing frames 11 on the ground (can also secure just portions to the ground), as well as securing portions of the first fixing member 501′ of the two third fixing units 50 to the ground, so that the movable combined wall modules 10 can be effectively secured to the ground.

Notably, the first fixing member 501 of the third fixing unit 50 is a shape corresponding to the coupling slot 112 to mutually couple with the coupling slot 112. In the preferred embodiment, the second fixing member 502 of the third fixing unit can also have a shape corresponding to the coupling slot 112 in order to be mutually coupled with the coupling slot 112. Namely, the two movable combined wall modules 10 can be mutually coupled through four third coupling units 50 and be arranged accordingly on the same longitudinal axis, whereas two sides of each movable combined wall module 10 can further be mutually coupled to the coupling slots 112 of another two movable combined wall modules 10 via the second fixing members 502 exposed from the third coupling units 50, so that the movable combined wall device 1 can be in a mode as shown in FIG. 11.

Please refer to FIGS. 10,11, 12 in conjunction with FIG. 2. Four movable combined wall modules 10 are arranged in the Y-Z plane as shown in FIG. 10, and are defined as upper left, lower left, upper right, and lower right movable combined wall modules 10. As shown in FIGS. 10 and 12, each coupling slot 112 of the upper left and lower left movable combined wall modules 10 can have a third coupling unit 50 arranged thereon, then accordingly the upper left and lower left movable combined wall modules 10 can be mutually coupled and be arranged on the same longitudinal axis. When the upper left and lower left movable combined wall modules 10 are mutually coupled to one another, the right side will correspondingly expose two second fixing members (not shown in figures) of third coupling units. Accordingly, the two movable combined wall modules 10, specifically the upper right and lower right movable combined wall modules, can be mutually coupled to the corresponding second fixing members, and be arranged on the same transversal axis as the two upper left and lower left movable combined wall modules 10.

The figures and descriptions supra set forth illustrate the preferred embodiments of the instant disclosure; however, the characteristics of the instant disclosure are by no means restricted thereto. All changes, alterations, combinations or modifications conveniently considered by those skilled in the art are deemed to be encompassed within the scope of the instant disclosure delineated by the following claims.

What is claimed is:

1. A movable combined wall device, comprising:
N movable combined wall modules, N being a positive integer, and each movable combined wall module comprising:
two fixing frames, each fixing frame having an inner side surface oppositely arranged from an outer side surface, the inner side surface of each fixing frame arranged to face the inner side surface of the other fixing frame, each inner side surface of each fixing frame having a guiding rail arranged thereon, each outer side surface of each fixing frame having a coupling slot arranged thereon;
a first operable window arranged between two fixing frames, the first operable window has at least two sides, and one side of the first operable window mutually fixed with one end of each of the two fixing frames; and
a second operable window arranged between two fixing frames, the second operable window has at least two sides, one side of the second operable window pivotally connected to the other side of the first operable window, the other side of the second operable window pivotally connected to two guiding rails, such that one side of the second operable window is movable proximate to or distal from a side of the first operable window fixed on one end of the two fixing frames along the two guiding rails; and
N-1 first coupling units, each first coupling unit simultaneously coupled to two coupling slots of two fixing frames, such that two movable combined wall modules are mutually fixed.

2. The movable combined wall device as recited in claim 1, wherein at least one coupling unit simultaneously coupled to two coupling slots, and the two outer side surfaces of the two fixing frames having the two coupling slots are arranged face to face with one another, such that the two movable combined wall modules are arranged on an identical transverse axis.

3. The movable combined wall device as recited in claim 2, wherein the movable combined wall device has at least two movable combined wall modules and two second coupling units, the movable combined wall modules are mutually coupled via at least one of the first coupling units, and another two coupling slots are mutually coupled to the two second coupling units, the two second coupling units are fixed on two oppositely facing fixed walls, the movable combined modules are fixed between the two fixed walls via at least one of the first coupling units and the two second fixing units.

4. The movable combined wall device as recited in claim 3, wherein each coupling slot has a surface area at an opening of one of the outer side surfaces smaller than the surface area of the coupling slot at a bottom surface of the fixing frame, and the cross-sectional area of each coupling slot is trapezoidal.

5. The movable combined wall device as recited in claim 4, wherein each movable combined wall module further comprises: two sliding units, two pivotable units, and one driving unit, the two sliding units are slidably disposed on two guiding rails, the two pivotable units are fixed on the two sliding units, the two sliding units are pivotally connected to two pivoting portions respectively arranged on two sides of two second operable windows, the driving unit is fixed on one of the fixing frames, and the driving unit is connected to the sliding unit in the fixing frame.

6. The movable combined wall device as recited in claim 5, wherein two ends of the respective two fixing frames of each movable combined wall module and one side of the first operable window have a fixing cover disposed thereon, each fixing cover has two connecting members disposed on a side of the first operable window of the movable combined wall module of the fixed wall, the fixing cover has two connecting portions corresponding to the two connecting members, and when the fixing cover is disposed on the movable combined wall module, the connecting members are pivotally connected to the corresponding connection portions.

7. The movable combined wall device as recited in claim 6, wherein each first coupling unit comprises a first fixing member and a second fixing member, the first fixing member and the second fixing member have shapes conforming to shapes of the coupling slots, the first fixing member and the second fixing member are respectively coupled to the corresponding coupling slots, when the first coupling unit is correspondingly disposed in the coupling slot, the first fixing member at one end of the first coupling unit is exposed from the coupling slot, the second fixing member at another end of the first coupling unit cooperatively forms a fixing slot with the coupling slot, and two first fixing members exposed from the movable combined wall module and having two first coupling units are correspondingly coupled to two fixing slots of another movable combined wall module having two first coupling units, so that two movable combined wall modules are arranged on one identical longitudinal axis.

8. The movable combined wall device as recited in claim 2, wherein the movable combined wall device has a movable combined wall module and two second coupling units, two of the coupling slots of the movable combined wall module and two of the second coupling units are mutually coupled, two of the second coupling units securely disposed on two fixed walls facing one another, and the movable combined module is securely disposed between two fixed walls by two of the second coupling units.
